(19) United States
(12) Patent Application Publication
(10) Pub. No.: US 2024/0318987 A1
(43) Pub. Date: Sep. 26, 2024

(54) SENSOR AND SYSTEM COMPRISING A SENSOR AND A FASTENING DEVICE

(71) Applicant: MICRO-EPSILON MESSTECHNIK GMBH & CO. KG, Ortenburg (DE)

(72) Inventors: Stefan STELZL, Ortenburg (DE); Norbert REINDL, Furstenzell (DE); Julian KASBERGER, Ruhstorf an der Rott (DE)

(21) Appl. No.: 18/580,052

(22) PCT Filed: Jul. 26, 2022
(86) PCT No.: PCT/DE2022/200171

§ 371 Date: Jan. 17, 2024

(30) Foreign Application Priority Data
Jul. 27, 2021 (DE) 10 2021 208 078.2

(51) Int. Cl. G01D 11/24; G01D 5/14

(52) U.S. Cl. CPC G01D 11/245; G01D 5/14

(57) ABSTRACT

A sensor for distance and/or position measurement has an essentially cylindrical housing and a sensor element operating according to the inductive, capacitive, or eddy current principle, which sensor element is arranged at least partially in the housing, wherein at least one fastening region is formed on the surface of the housing, which fastening region extends around the housing in the circumferential direction and is arranged as a raised portion or as a recess, wherein the housing is connectable in a force-fitting manner exclusively with the fastening region to a fastening device. Furthermore, a system including of such a sensor and a fastening device is shown.

### CROSS REFERENCE

This application is a national stage entry application under 35 U.S.C. 371 of PCT Patent Application No. PCT/DE2022/2000171, filed on Jul. 26, 2022 which claims priority to German Patent Application No. 10 2021 208 078.2, filed on Jul. 27, 2021, the entire contents of each of which are incorporated herein by reference.

### FIELD

The present disclosure relates to a sensor for distance and/or position measurement having an essentially cylindrical housing and a sensor element operating according to the inductive, capacitive or eddy current principle, which is at least partially arranged in the housing. The present disclosure further relates to a system comprising such a sensor and a fastening device.

### BACKGROUND

Sensors for distance measurement are employed at different temperatures and distances. If a distance is to be measured in a very accurate manner, it is important to know the thermal expansion of the sensor due to temperature changes or to define it as accurately as possible in order to be able to compensate for this as well as possible.

Cylindrical sensors without thread are usually clamped in a clamping device. For this type of clamping, the exact location of the force-fitting connection between the clamping device and the sensor housing is not known. With circumferential clamping in particular, it is unclear where the sensor is actually “clamped.” Due to slight tolerances in the sensor housing or the clamping device, or due to small impurities (dust, or grease/oil) in the clamping, the location of the force-fitting connection cannot be accurately determined or may even change over time or under changing temperatures.

If the temperature rises, the sensor expands with the typical material-specific expansion coefficient of the housing, starting from the clamping point. At the same time, the clamping device also expands due to its own material-specific expansion coefficient. This causes the measuring element (electrode/coil) of the sensor to move towards or away from the measurement object due to the expansion, depending on the materials of the sensor and the clamping device. This results in a measurement error, as the distance to the measurement object changes due to the clamping.

In many measurement tasks, however, only the position of the measurement object is important, and it must therefore be possible to eliminate the influence of the temperature expansion of the sensor and clamping device as far as possible.

Especially with precision measurements, for example with capacitive sensors, the influence of different temperature expansion cannot be neglected. Such sensors often have a resolution in the nanometer range. A nickel steel with low thermal expansion (e.g., INVAR with a thermal expansion coefficient α=1·10⁻⁶/K) is often used as the material for these sensors, since the active sensor surface should be kept as constant as possible in the event of temperature changes.

If the clamping device is made of conventional steel, e.g. stainless steel (1.4301, α=16·10⁻⁶/K), a relative expansion of (16−1)·10⁻⁶/K·100K·10 mm=15 μm may occur, for example, with a clamping device 10 mm wide (i.e., the location of the clamping is undefined to a maximum of 10 mm) and a temperature change of 100° C. in the application. This is a significant measurement error when measuring in the nanometer range.

### SUMMARY

The present disclosure therefore has the objective of designing and further developing a sensor and a system comprising a sensor and a fastening device in such a way that reliable measurement at different temperatures is made possible by simple design means.

According to the present disclosure, the aforementioned object is achieved, in an embodiment, in reference to the sensor by means of the features of claim 1. Accordingly, the sensor in question for distance and/or position measurement has an essentially cylindrical housing and a sensor element operating according to the inductive, capacitive or eddy current principle, which sensor element is arranged at least partially in the housing, wherein at least one fastening region is formed on the surface of the housing, which fastening region extends around the housing in the circumferential direction and is arranged as a raised portion or as a recess, wherein the housing is connectable in a force-fitting manner exclusively with the fastening region to a fastening device.

The above-mentioned objective is achieved, in an embodiment, with respect to the system by the features of claim 12. A system comprising a sensor according to one of claims 1 to 11 and a fastening device is thus specified, wherein the fastening device has an opening for receiving the sensor and wherein the housing may be fixed in and/or on the opening of the fastening device exclusively with its fastening region in a force-locking manner.

In accordance with the present disclosure, it has been recognized that an improved clamping of the at least essentially cylindrical sensor may be achieved by reproducibly determining the location of the clamping by the defined fastening region, in an embodiment, the sensor is in contact with the fastening device exclusively with its fastening region. This makes it possible to compensate for the measurement error due to the different temperature expansion. In other words, the location of the adhesion may be accurately defined by the fastening region. On this basis, the expansion of a known point or a very small area may be calculated in the subsequent measurement application or the measurement may then be repeated extremely accurately over the entire operating temperature range and may be actively compensated for in the measurement system.

The term “cylindrical” is to be understood in the broadest sense. This does not necessarily mean that it is a circular cylinder, it may also have other shapes, such as an angular or oval base area, be skewed, and/or the base area may change over the height of the cylinder.

In an embodiment, the raised portion may have a maximum height of 0.05 mm and/or the recess may have a maximum depth of 0.05 mm. This allows the fastening region to be realized in a structurally simple way. Alternatively or additionally, the housing may be made of steel, for example stainless steel, or a steel alloy.

In a further embodiment, the fastening region may be delimited by material recesses from the surface of the housing outside the fastening region. This design measure makes it possible to position the sensor in a particularly simple manner relative to the fastening device. It is also conceivable that the material recesses are V-shaped or U-shaped or semi-circular or trapezoidal. Corresponding geometries may be produced by turning, for example.

According to another embodiment, the fastening region may be formed by a large number of point-shaped raised portions. Due to the point-shaped raised portions, improved adhesion or improved clamping may be generated between the sensor and the fastening device. In this case, it is possible that the point-shaped raised portions are formed in one piece with the housing, i.e., are machined out of the housing. Alternatively, the raised portions may be applied to the housing.

In a further embodiment, the fastening region may extend in a ring shape around the housing. Such a circumferential ring may be easily machined during the manufacture of the housing, for example by turning the housing.

In a particular embodiment, the width of the ring-shaped fastening region may be selected to be as small as possible and at the same time matched to the size of the housing in such a way that the fastening region is sufficiently wide to prevent the housing from tilting when connected to the fastening device. The width of the annular fastening region should be made as small as possible in order to define the location of the force-fitting connection or clamping as precisely as possible. However, it should be noted that if the annular fastening region is too narrow, there is a risk of the sensor tilting in the fastening device. The decisive factor is the ratio of the width of the annular fastening region to the length of the housing, or the length of the fastening device. This results in an area on the housing which then allows a much more precisely defined location of the force-fitting connection in the fastening device. In an embodiment, the fastening region may have a width in the range of 0.5 mm to 2.5 mm, in particular from 1 mm to 2 mm. Alternatively or additionally, a distance between a measuring surface of the sensor and the fastening region may be formed in the axial direction of the sensor in such a way that compensation of the different temperature expansion of the housing and the fastening device is at least achieved. In other words, this distance may be selected such that optimal compensation of the different thermal expansion coefficients of the sensor housing and fastening device is achieved. In particular, the distance between the measuring surface of the sensor (sensor front side) and the fastening region, viewed in the direction of extension of the sensor, could be 0.5 mm to 1.5 mm, preferably 2 mm. The lower the expansion coefficient of the material of the sensor housing, the further towards the fastening region or the sensor end face the fastening region may be arranged.

According to an embodiment, the fastening region may run in a ring around the housing and the outer diameter of the housing in the fastening region may be larger than the outer diameter of the housing outside the fastening region. Specifically, it is conceivable that the outer diameter of the housing in the fastening region is at most 0.05 mm, at most 0.02 mm, and/or 0.01 mm, larger than the outer diameter of the housing outside the fastening region. The ratio of the outside diameters of the fastening region and the rest of the housing to one another should be chosen appropriately. For larger sensors, a larger outer diameter of the fastening region will be sufficient, for example 0.05 mm for a housing diameter of 10 mm; for smaller sensors, the outer diameter of the fastening region should be smaller, for example 0.01 mm for an outer diameter of the housing of 5 mm.

In an embodiment, the fastening device is designed in such a way that the sensor may be connected to the fastening device with a circumferential clamp. Alternatively, it is conceivable that the sensor may be arranged in the opening in such a way that a fastening means, for example a fastening screw or a fastening pin, engages with the fastening region of the housing.

There are then various possibilities for advantageously designing and refining the teaching of the present disclosure. For this purpose, reference is made, on the one hand, to the claims subordinate to claims 1 and 12 and, on the other hand, to the following explanation of exemplary embodiments of the present disclosure with reference to the drawings. In connection with the explanation of the exemplary embodiments of the present disclosure with reference to drawings, embodiments and refinements of the teachings are also explained in general.

### BRIEF DESCRIPTION OF THE SEVERAL VIEWS OF THE DRAWINGS

FIG. 1a is a schematic representation of a side view of a sensor according to the present disclosure,

FIG. 1b is a schematic representation of a front view of a sensor according to the present disclosure,

FIG. 1c is a schematic representation of an enlarged section of FIG. 1a,

FIG. 2 is a schematic representation of a sectional view of a system according to the present disclosure,

FIG. 3 is a schematic representation of another partially sectioned view of the system according to FIG. 2,

FIG. 4 is a schematic representation of a partially sectioned view of a further embodiment of a system according to the present disclosure,

FIG. 5 is a schematic representation of another partially sectioned view of the system according to FIG. 4,

FIG. 6 is a schematic representation of a sectional view of a system, and

FIG. 7 is a schematic representation of a sectioned view of a further embodiment of a system according to the present disclosure.

### DETAILED DESCRIPTION OF THE DISCLOSURE

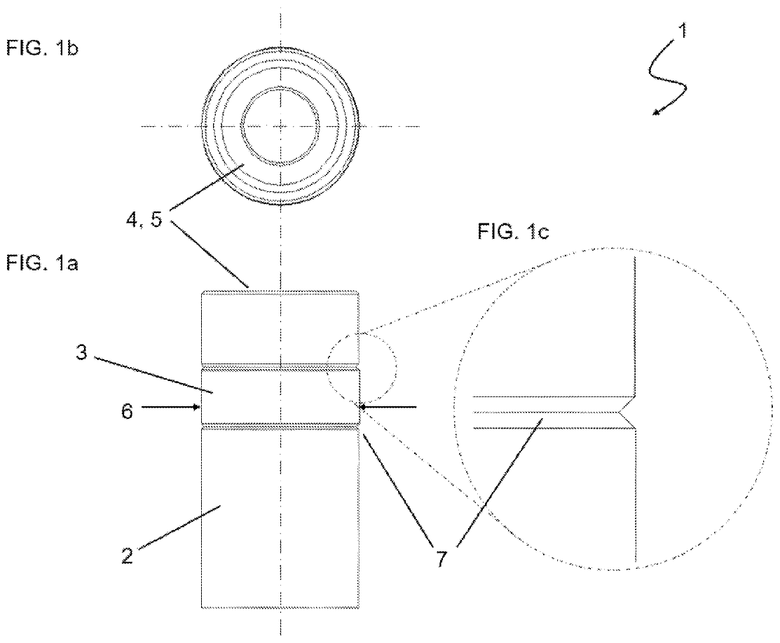

FIGS. 1a to 1c show a sensor 1, for example a capacitive displacement sensor, that may for instance have a measuring range of 0.2 mm. An annular fastening region 3 is formed on the housing 2, while the fastening region 3 may also have a different geometry. The annular fastening region 3 may be located, for example, approximately 3 mm to 5 mm behind the measuring surface 4 of the sensor element 5 (FIG. 1 b). The housing 2 of the sensor 1 may, for example, have an outer diameter of 6 mm and a length of 12 mm. With such a dimensioning of the housing 2, the annular fastening region 3 may, for example, have an outer diameter 6 that is 0.01 mm larger than the remaining outer diameter of the (cylindrical) housing 2 of the sensor 1. The width of the annular fastening region 3 may, for example, be 2 mm. This means that the position of the force-fitting connection may be precisely defined by the fastening region 3, which means that temperature-related expansion may be compensated for when recording the measured value.

Furthermore, it may be seen that the annular fastening region 3 is delimited from the rest of the housing 2 by material recesses 7, which are configured as V-shaped recesses (shown enlarged in FIG. 1c).

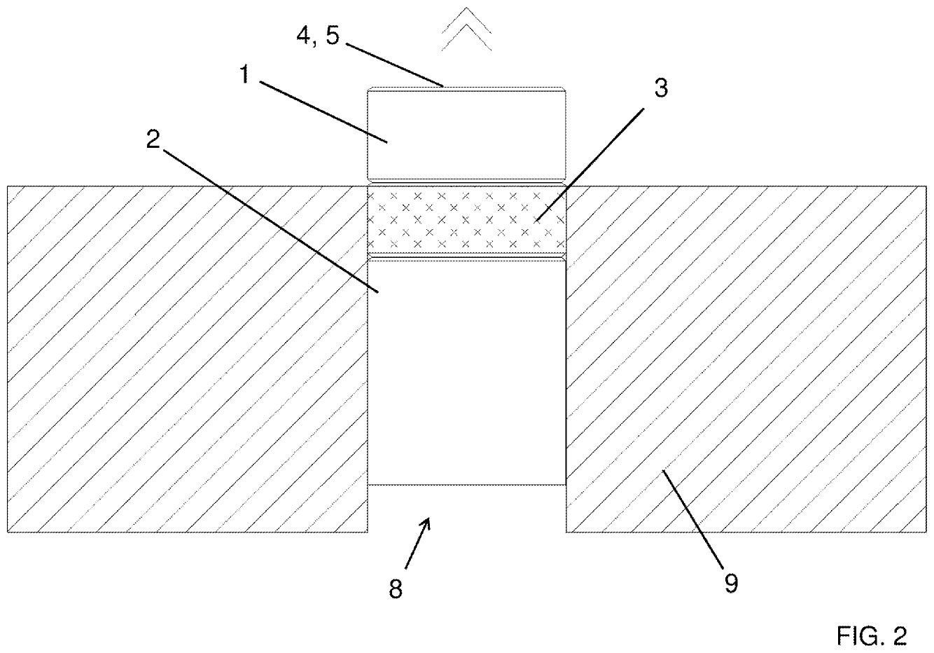

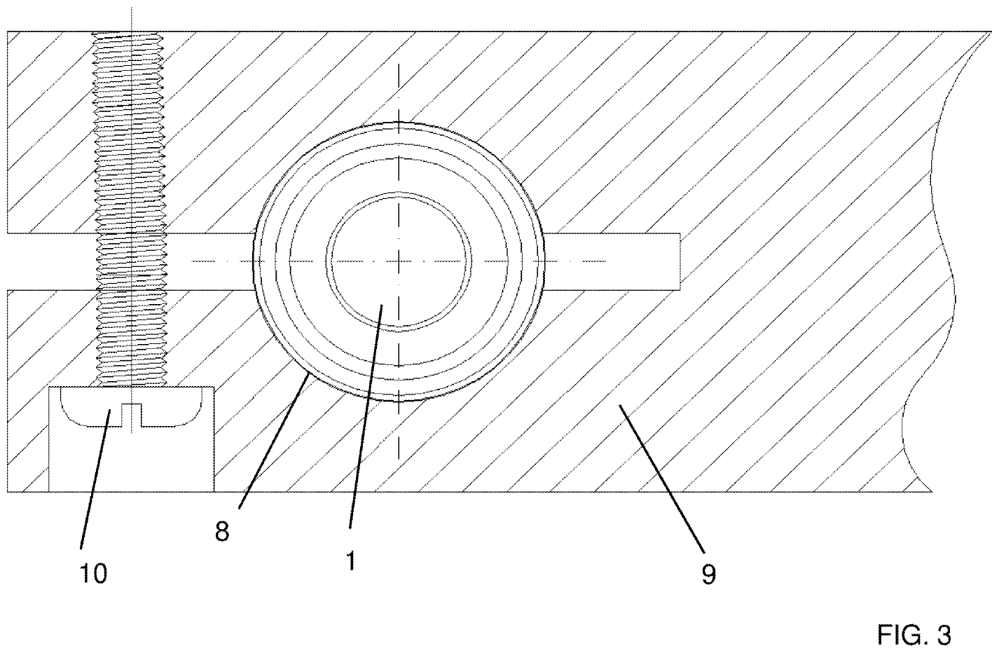

In the exemplary embodiment shown in FIGS. 2 and 3, the sensor 1 also has an annular fastening region 3 on the housing 2. Furthermore, it may be seen that the sensor 1 is inserted into an opening 8 of the fastening device 9. Since the outer diameter 6 of the annular fastening region 3 is slightly larger than the outer diameter of the remaining housing 2, the sensor 1 is clamped to the fastening device 9 exclusively via the fastening region 3. To create the circumferential clamping, the fastening means 10, which is configured as a screw, is tightened.

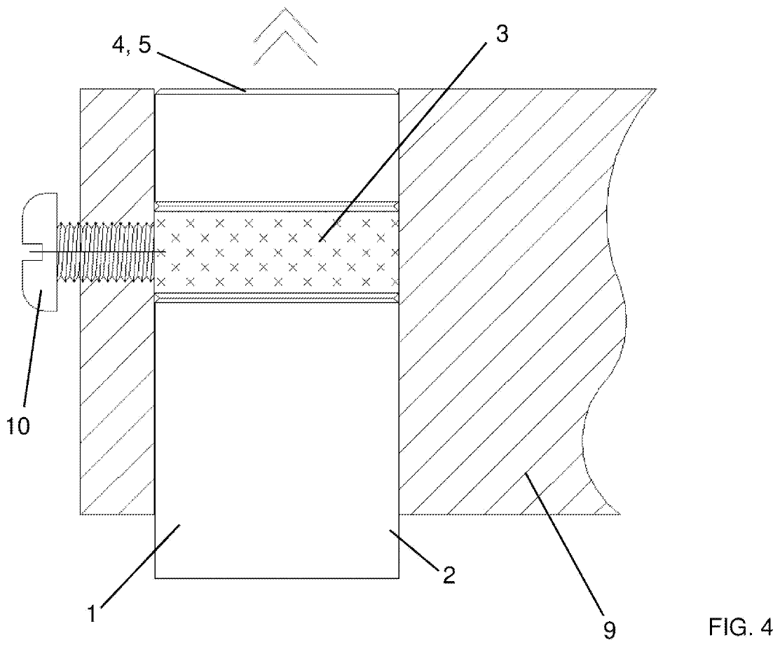

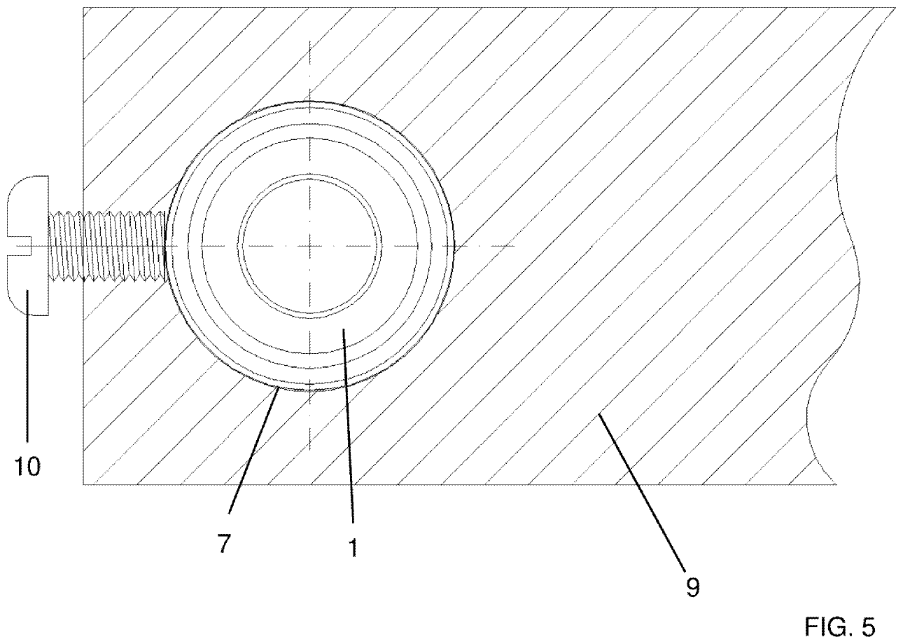

The embodiment example shown in FIGS. 4 and 5 corresponds to the embodiment example shown in FIGS. 2 and 3, with the difference that the location of the clamping is determined by the ring-shaped fastening region 3 and the position of the fastening means 10, which is designed as a screw. It may be seen that the screw 10 lies precisely against the defined fastening region 3 and thus causes the clamping at a position that is defined with utmost accuracy.

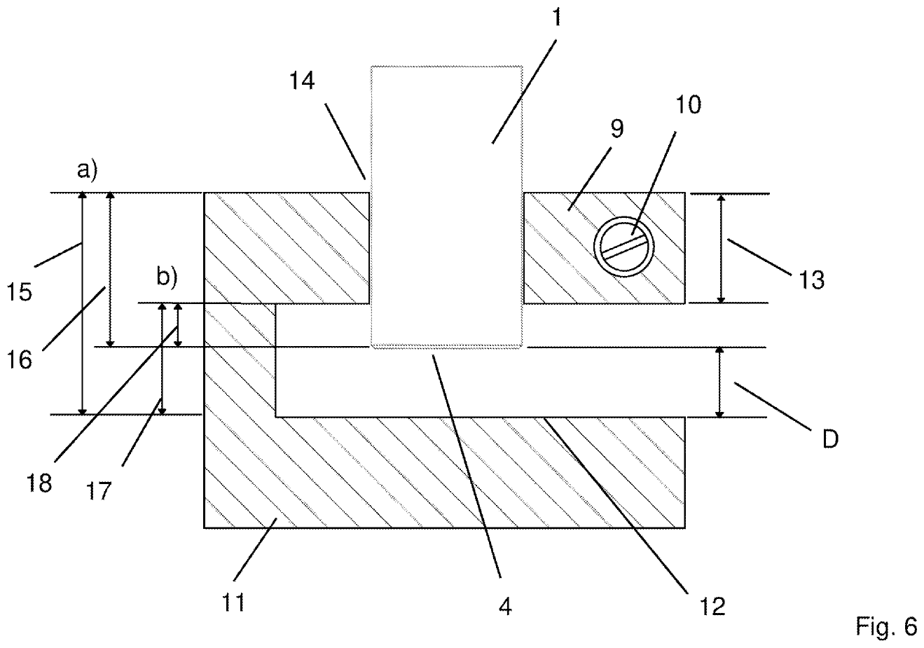

FIG. 6 shows a system where the sensor 1 has no fastening region. If the sensor 1 is clamped in a holder 11 with fastening device 9, the measuring surface 4 has a certain basic distance D from the contact surface 12 for the object to be measured (not shown), which is defined according to the measuring task. This basic distance D changes with changing temperatures due to the different temperature-dependent expansion coefficients of the materials used.

If, for example, the sensor 1 is made of stainless steel (V4A) and the fastening device 9 is made of aluminum, it expands more than the housing 2 of the sensor 1 when the temperature increases, which increases the basic distance D. If the sensor 1 does not have a defined fastening region 3, the location of the force-fitting connection in the axial direction along the clamping region 13 is undefined. In extreme cases, the force-fitting connection could be right at the beginning (in the direction of measuring surface 4) or at the end (in the direction of the cable outlet/connector).

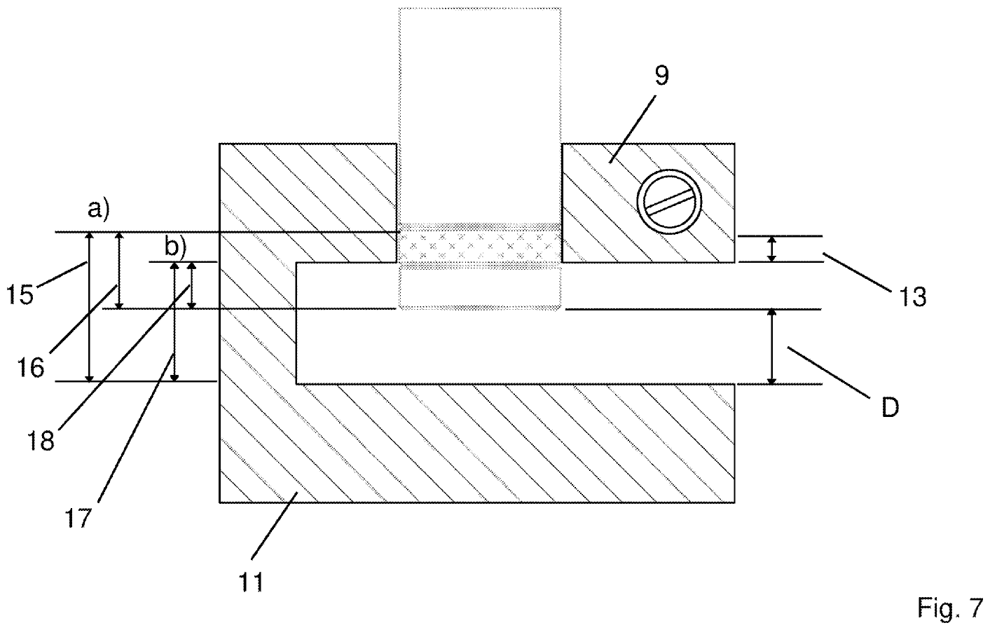

FIGS. 6 and 7 show these two extreme cases as variants a) and b): In case a), the location of the force-fitting connection is closer to the connector-side end 14 of the sensor 1. The relative expansion of the fastening device 9, symbolized by the arrow 15, acts over the entire length 15. In contrast, the expansion of the sensor 1 acts in the opposite direction, symbolized by the arrow 16. Due to the different expansion coefficients, the resulting change in the basic distance D is very large. In case b), the location of the force-fitting connection is at the frontal measuring surface 4 of sensor 1. The relative expansion of the fastening device, symbolized by arrow 17, acts over the entire length 17. In contrast, the expansion of sensor 1 acts in the opposite direction, symbolized by arrow 18. Due to the different expansion coefficients, the resulting change in the basic distance D is small.

Depending on the length of the clamping region 13, the relative expansion may therefore be different, whereby the basic distance D changes in a non-reproducible manner with correspondingly detrimental effects on the measurement result.

FIG. 7 shows that the location of the force-fitting connection is easier to reproduce, even with changing temperatures, if the location of the force-fitting connection is defined locally, in this case in a clamping region 13 that is narrowly limited in the axial direction, with the aid of the fastening region 3. Depending on the application and the materials used, the location may be closer to the measuring surface 4, for example, or closer to the cable outlet/connector in the opposite direction.

To avoid repetition with regard to further advantageous embodiments of the device according to the present disclosure, reference is made to the general part of the description and to the appended claims.

Finally, it should be expressly noted that the above-described exemplary embodiments of the device according to the present disclosure merely serve to discuss the claimed teaching, but do not restrict it to the exemplary embodiments.

### LIST OF REFERENCE NUMERALS

1 Sensor
2 Housing
3 Fastening region
4 Measuring surface
5 Sensor element
6 Outer diameter (fastening region)
7 Material recesses
8 Opening
9 Fastening device
10 Fastener
11 Holder
12 Bearing surface
13 Clamping region
14 Connector-side end
15 Expansion (fastening device)
16 Expansion (sensor)
17 Expansion (fastening device)
18 Expansion (sensor)

1. A sensor for distance and/or position measurement having an essentially cylindrical housing and a sensor element operating according to inductive, capacitive, or eddy current principles, which is at least partially arranged in the housing, comprising:
at least one fastening region is formed on the surface of the housing, which fastening region extends around the housing in the circumferential direction and is formed as a raised portion or as a recess, wherein the housing is connectable in a force-fitting manner exclusively with the fastening region to a fastening device.

2. The sensor according to claim 1, wherein the raised portion has a height of a maximum of 0.05 mm and/or wherein the at least one recess has a depth of a maximum of 0.05 mm.

3. The sensor according to claim 1, wherein the fastening region is delimited by material recesses from the surface of the housing outside the fastening region.

4. The sensor according to claim 3, wherein the material recesses are V-shaped or U-shaped or semicircular or trapezoidal.

5. The sensor according to claim 1 wherein the fastening region is formed by a plurality of point-shaped raised portions.

6. The sensor according to claim 5, wherein the point-shaped raised portions are integrally formed with the housing or are applied to the housing.

7. The sensor according to claim 1, wherein the fastening region extends in a ring shape around the housing.

8. The sensor according to claim 1, wherein the width of the annular fastening region is chosen to be as small as possible and at the same time matched to the size of the housing in such a way that the fastening region is sufficiently wide to prevent the housing from tilting when connected to the fastening device.

9. The sensor according to claim 1, wherein the fastening region runs in a ring around the housing and wherein an outer diameter of the housing in the fastening region is larger than a outer diameter of the housing outside the fastening region.

10. The sensor according to claim 9, wherein the outer diameter of the housing in the fastening region is at most one of:
0.05 mm larger than that diameter of the housing outside the fastening region;
at most 0.02 mm larger than that diameter of the housing outside the fastening region and:
0.01 mm, larger than that diameter of the housing outside the fastening region.

11. The sensor according to claim 1, wherein in an axial direction of the sensor, a distance between a measuring surface of the sensor and the fastening region is formed in such a way that compensation of the different temperature expansion of the housing and the fastening device is achieved.

12. A system comprising a sensor according to claim 1 and a fastening device, wherein the fastening device has an opening for receiving the sensor (1) and wherein the housing is connectable in a force-fitting manner exclusively with its fastening region to the fastening device.

13. The system according to claim 12, wherein the fastening device is configured so that the sensor may be connected to the fastening device with a circumferential clamp.

14. The system according to claim 13, wherein the sensor may be arranged in the opening in such a way that a fastening means engages the fastening region of the housing.
